(19) United States
(12) Patent Application Publication
(10) Pub. No.: US 2018/0353371 A1
(43) Pub. Date: Dec. 13, 2018

(54) MIMETIC MUSCLE TRAINING METHOD, AND MASSAGE ROLLER

(71) Applicant: SHIKAHAMA CO., LTD., Adachi-ku (JP)

(72) Inventor: Shigeru SHIKAHAMA, Adachi-ku (JP)

(73) Assignee: SHIKAHAMA CO., LTD., Adachi-ku (JP)

(21) Appl. No.: 16/104,171

(22) Filed: Aug. 17, 2018

Related U.S. Application Data
(63) Continuation of application No. PCT/JP2017/022829, filed on Jun. 21, 2017.

(30) Foreign Application Priority Data
Jul. 13, 2016 (JP) PCT/JP2016/070678

(51) Int. Cl. A61H 15/00

(52) U.S. Cl. CPC A61H 15/0092; A61H 2015/0014; A61H 2205/022; A61H 2201/1692; A61H 2201/1261

(57) ABSTRACT

There is provided a method for training a mimetic muscle, comprising preparing a massage roller, the massage roller including a roller base made of a material free of elastic deformation, and a plurality of elastic ridges formed on a circumferential roller surface of the roller base so as to continuously extend in a direction along an axis of rotation of the roller base such that adjacent ridges in a rotational direction of the roller base are spaced; and creating a certain facial expression on a face so as to contract, in a contracting direction, a mimetic muscle to be trained; and reciprocating the massage roller along a continuously extending direction of the mimetic muscle with a location of a face skin corresponding to one end portion of the mimetic muscle being pressed so as to pull the mimetic muscle in a direction opposite to the contracting direction.

### TECHNICAL FIELD

The present invention relates to a method for training a mimetic muscle by use of a massage roller, and a massage roller suited to the method.

### BACKGROUND ART

Mimetic muscles are included in skeletal muscles. The mimetic muscles are characterized to have one end connected to mainly a skin for the purpose of creating a facial expression. The mimetic muscles are muscles that can be reinforced by the application of a proper load as in the other skeletal muscles.

It has been proven that passive extension exercise of muscles, in other words, mechanical stimulation exercise enhances muscles. Finger-pressure treatment is an example of such technique. For example, if a mimetic muscle of a human face is atrophied by aging, it is supposed that it is effective to apply finger-pressure treatment to the atrophied muscle for restoration.

The applicant has disclosed, in Patent Document 1, a massage roller which is rotated and moved on a human body, being pressed against the body, such that a similar effect to finger-pressure treatment is properly and continuously given to the body.

### PRIOR ART DOCUMENTS

### Patent Documents

Patent Document 1: Japanese Patent No. 5547537

### DISCLOSURE OF INVENTION

### Technical Problem

The applicant has found a method for effectively training a mimetic muscle by use of the massage roller.

More specifically, the applicant has found a method for training a mimetic muscle by use of the massage roller to more effectively correct a loose skin or flabbiness in a face caused by aging or another factor.

According to a first aspect of the present invention, there is provided a method for effectively training a mimetic muscle by use of the massage roller.

According to a second aspect of the present invention, there is provided a massage roller which is more suited to train a mimetic muscle.

### Solution To Problem

In order to solve one of the problem, according to a first aspect of the present invention, there is provided a method for training a mimetic muscle, which includes preparing a massage roller, the massage roller including a roller base made of a material free of elastic deformation, and a plurality of elastic ridges formed on a circumferential roller surface of the roller base so as to continuously extend in a direction along an axis of rotation of the roller base such that adjacent ridges in a rotational direction of the roller base are spaced; creating a certain facial expression on a face so as to contract, in a contracting direction, a mimetic muscle to be trained; and reciprocating the massage roller along a continuously extending direction of the mimetic muscle with a location of a face skin corresponding to one end portion of the mimetic muscle being pressed so as to pull the mimetic muscle in a direction opposite to the contracting direction.

Since the massage roller is configured to combine the roller base made of a material free of elastic deformation and the elastic ridges, and since the massage roller is pressed against a human body as in finger-pressure treatment while the massage roller is rotated and moved on the human body, the massage roller applies a similar effect to finger-pressure treatment to the human body without damaging the face skin. In other words, the roller base works so as to correspond to a finger bone in finger-pressure treatment while each of the elastic ridges work so as to correspond to the flesh of a finger pad in finger-pressure treatment. The massage roller applies, at a contact end with the face, a sufficient load to the mimetic muscle to be trained as in finger-pressure treatment since the massage roller is brought into contact with the human body with the elastic ridges formed on the circumferential roller surface of the roller. Since the massage roller includes the elastic ridges along the axis of rotation of the roller base, the massage roller is rotated and moved on the skin along the continuously extending direction of the mimetic muscle to be trained such that the load is applied in a direction to loosen and apply a shear stress to myofibrils forming the mimetic muscle to be trained, in order to promote metabolism of the mimetic muscle.

When the mimetic muscle to be trained is contracted in a certain contracting direction by creating a certain facial expression, a first load is applied to the mimetic muscle to be trained.

A second load can be applied to the mimetic muscle to be trained, in a state where tension is firmly applied to the mimetic muscle by pressing a location of a face skin corresponding to one end portion of the mimetic muscle and pulling the muscle in a direction opposite to the contracting direction with the first load being applied to the mimetic muscle.

It is possible to effectively give mechanical stimulations to the mimetic muscle to be trained by reciprocating the massage roller along the continuously extending direction of the mimetic muscle with a proper pressure applied to the mimetic muscle in a state where the first and second loads are applied to the mimetic muscle.

In order to solve the other problem, according to a second aspect of the present invention, there is provided a massage roller, which includes a roller base made of a material free of elastic deformation, and a plurality of elastic ridges formed on a circumferential roller surface of the roller base so as to continuously extend in a direction along an axis of rotation of the roller base such that adjacent ridges in a rotational direction of the roller base are spaced; the roller base having a coating layer disposed on the circumferential roller surface, the coating layer being made of a synthetic resin having a rubber-like elasticity and free of resin-allergy; and the elastic ridges being formed of parts of the coating layer, and each of the elastic ridges having a distance from a root to a leading edge thereof, which is within a range longer than 2 mm and shorter than 10 mm.

The provision of the coating layer prevents the roller base from being brought into direct contact with a face skin when the massage roller is pressed against the face. The coating layer is made of a synthetic resin free of resin-allergy. This arrangement provides the massage roller with a soft feeling of touch and minimizes the occurrence of a rough skin or resin allergy caused by the massage roller. Since the elastic ridges are configured such that each of the elastic ridges has the distance from the root to the leading edge thereof, which is longer than 2 mm and shorter than 10 mm, an external force can be effectively applied, via the massage roller, to a desired one of mimetic muscles having a multilayer structure.

### Advantageous Effects of Invention

In accordance with the present invention, it is possible to effectively train a mimetic muscle by use of a massage roller, which is pressed against a human body and is rotated and moved on the human body to properly and continuously apply a similar effect to finger-pressure treatment.

### BRIEF DESCRIPTION OF DRAWINGS

FIG. 1 is a front view of the massage roller according to an embodiment (as a first example) of the present invention.

FIG. 2 is a cross-sectional view of essential parts of the massage roller (as the first example).

FIG. 3 is a schematic front view of a massage device having the massage roller (as the first example) combined with a support.

FIG. 4 is a front view of the massage roller according to another embodiment (as a second example) of the present invention.

FIG. 5 is a side view of the massage roller (as the second example), which is partly shown in section.

FIG. 6 is a cross-sectional view of essential parts of the massage roller (as the second example).

FIG. 7 is a schematic front view of a massage device having the massage roller (as the second example) combined with a support.

FIG. 8 is a side view of the massage device having the massage roller (as the second example) combined with the support.

FIG. 9 is a schematic cross-sectional view showing a state where the massage roller (as the second example) is pressed against a face cheek of a human body.

FIG. 10 is a schematic cross-sectional view showing a state where the massage roller (as a comparative example), which is configured such that each elastic ridge has a shorter distance from a root to a leading edge thereof than the second example, is pressed against the face cheek of the human body.

FIG. 11 is a schematic cross-sectional view of a part of a face cheek of a human body.

FIG. 12 is an illustrative view showing how frontal muscles as parts of the mimetic muscles on a human face are arranged.

FIG. 13 is an illustrative view showing how a first load is applied to the frontal muscles.

FIG. 14 is an illustrative view showing how a second load is further applied to the frontal muscles.

FIG. 15 is an illustrative view showing how the massage roller gives mechanical stimulations to the frontal muscles in a state shown in FIG. 14.

### DESCRIPTION OF EMBODIMENTS

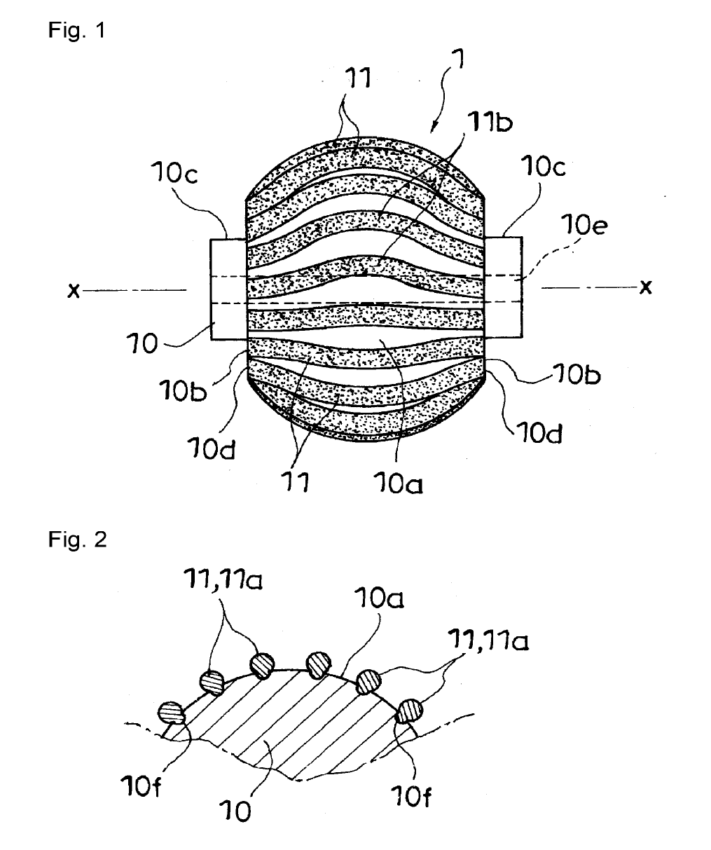

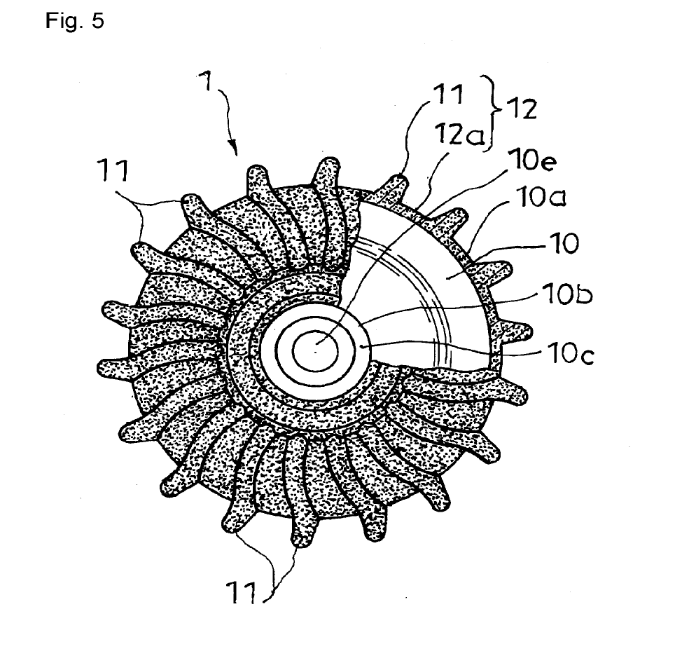

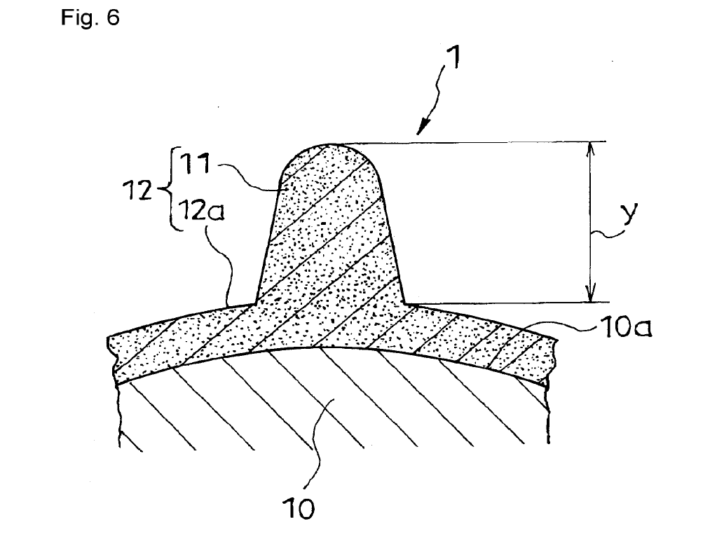

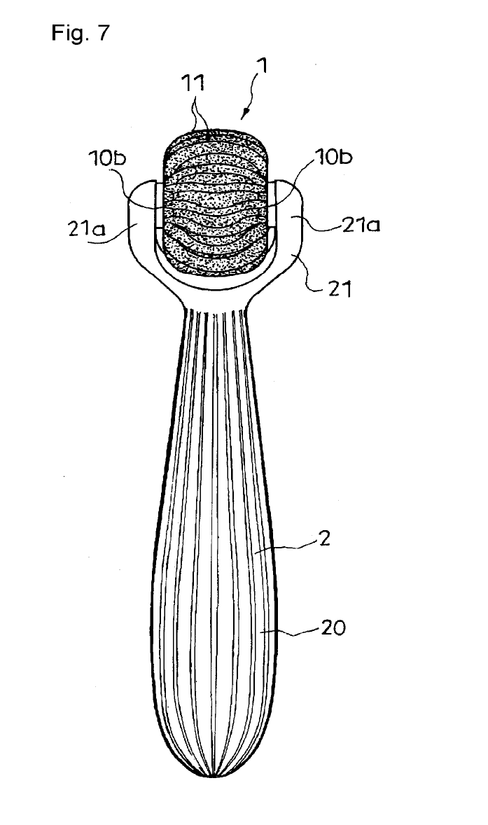

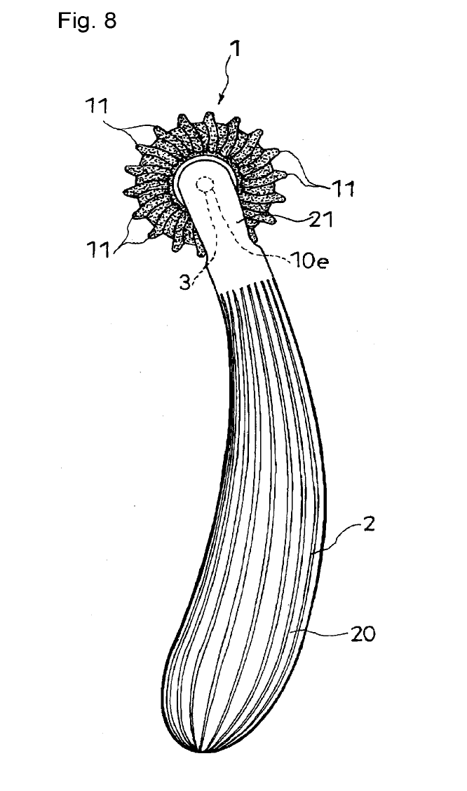

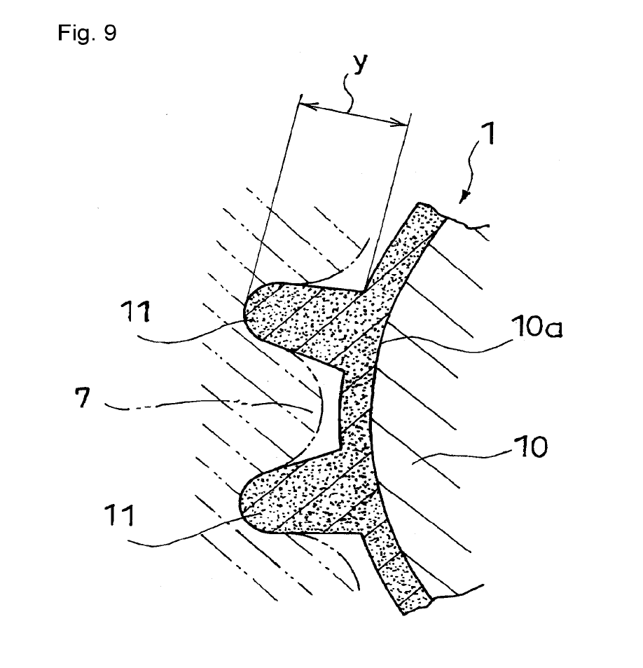

Now, typical embodiments of the present invention will be described based on FIGS. 1 to 15. The method for training a mimetic muscle according to the embodiments allows a mimetic muscle to be effectively trained by use of a massage roller 1 described later.

Specifically, the method for training a mimetic muscle according to these embodiments can effectively correct a loose skin or flabbiness in a face caused by aging or another factor.

The massage roller 1 is pressed against a face and is rotated and moved on the face to train a mimetic muscle which is present at a position that the massage roller is pressed.

Specifically, the massage roller 1 is supported so as to be rotatable about a single axis of rotation x. The mimetic muscle is trained by using the massage roller such that a circumferential roller surface 10 of a roller base 10 forming the massage roller is pressed against a face while the massage roller is rotated about the axis of rotation x and is moved on the face in a repeated manner, in other words, forward movement and backward movement are done alternately.

More specifically, the massage roller 1 is used with a certain range of pressing force applied to the face to effectively promote metabolism of the myofibrils forming the muscle fibers forming the mimetic muscle, resulting in reinforcement of the muscle fibers. As a typical example, it is revealed that the metabolism of the myofibrils, in other words, the destruction and regeneration of the myofibrils, is effectively promoted when elastic ridges 11 described later are pressed against a human body at a load of from 15 g to 30 g per 1 mm².

The massage roller 1 may include the roller base 10 formed so as to have a circumferential roller surface 10a substantially following the spherical surface of an imaginary globe, and the plural elastic ridges 11, 11 . . . disposed on the circumferential roller surface 10a of the roller base 10.

In the shown example, the roller base 10 has end surfaces 10b formed on both left and right sides with respect to the center of the imaginary globe so as to extend perpendicular to the axis of rotation x such that a portion of the surface of the roller base between the left and right end surfaces serves as the circumferential roller surface 10a.

In the shown example, each of the left and right end surfaces 10b and 10b has a boss section 10c formed therein, and the roller base 10 has a bore 10e formed therethrough so as to extend along the axis of rotation x.

In the shown example, the massage roller 1 is configured to be rotatably carried on a support 2 by a shaft 3 passing through the bore 10e.

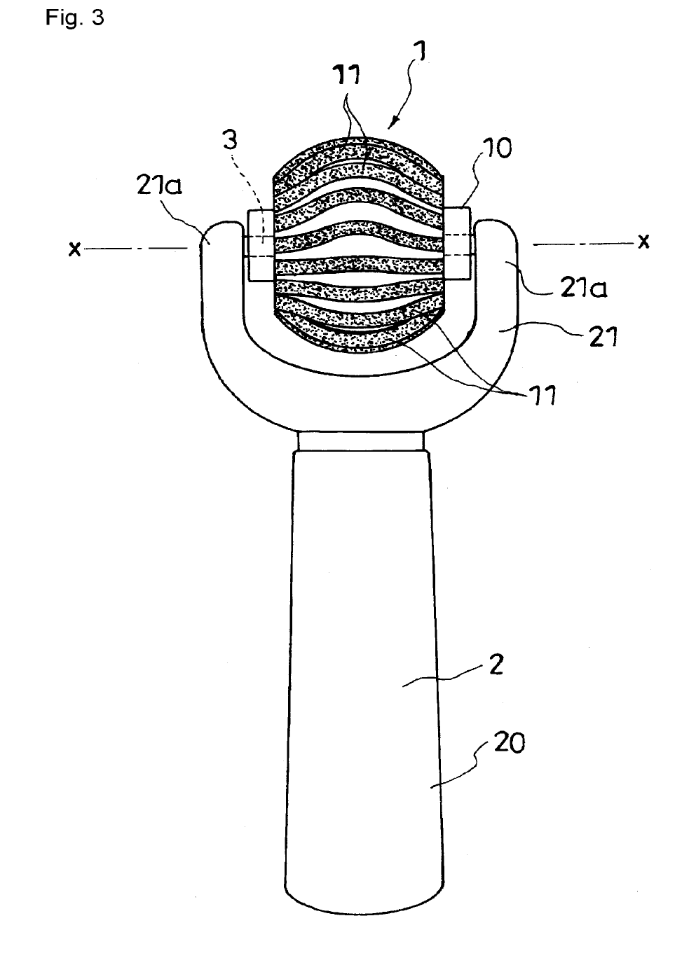

FIGS. 3, 7 and 8 show examples of the support 2. In each of the shown examples, the support 2 includes a stick-shaped grip 20 and a U-shaped head 21 disposed on one end of the grip such that the massage roller 1 is rotatably supported between both left and right ends 21a and 21a of the head 21 via the shaft 3. The massage roller 1 is combined with a proper support like the support 2 to form a massage device.

The roller base 10 is made of a material that is hard enough to be free of elastic deformation when the circumferential roller surface 10a is pressed against a human body so as to apply the above-mentioned load to the human body. Typically, the roller base 10 is made of metal or a hard synthetic resin.

On the other hand, the elastic ridges 11 are made of a material that is properly elastically deformable when the circumferential roller surface 10a of the roller base 10 is pressed against a face so as to apply the above-mentioned load to the face. The elastic ridges 11 are made of a synthetic resin having a rubber-like elasticity.

In the first example shown in FIGS. 1 to 3, the elastic ridges 11 are fixed on the circumferential roller surface 10a so as to extend from an edge part 10d defined by the circumferential roller surface 10a and the left end surface 10b of the roller base 10 to an edge part 10b defined by the circumferential roller surface 10a and the right end surface 10b of the roller base 10. In the shown example, adjacent ridges 11 are spaced at an equal distance therebetween throughout the rotational direction of the roller base 10.

It should be noted that each of the elastic ridges 11 is slightly curved at a substantially intermediate portion 11b in a longitudinal direction thereof in the shown example.

Typically, the roller base 10 may be configured such that the circumferential roller surface substantially follows the spherical surface of an imaginary globe, which has a diameter in a range of from 20 mm to 60 mm.

In the first example shown in FIGS. 1 to 3, each of the elastic ridges 11 is disposed on the roller base 10 such that a string-like member 11a, which is made of an elastically deformable material, has a lower longitudinal part embedded in a groove 10f formed in the roller base 10 and fixed in the groove 10f by an adhesive.

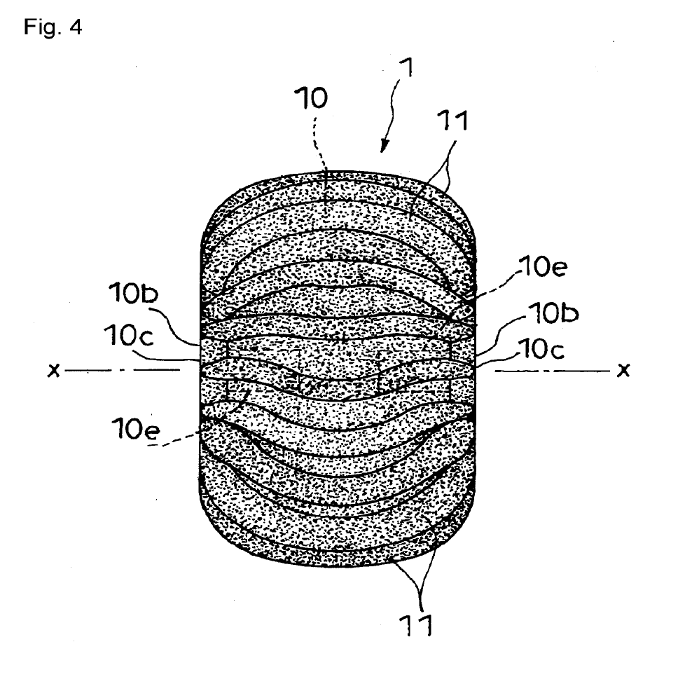

In a second example shown in FIGS. 4 to 9, the roller base 10 has a coating layer 12 disposed on the circumferential roller surface 10a, the coating layer being made of a synthetic resin having a rubber-like elasticity and free of resin-allergy. In addition, elastic ridges 11 are formed by parts of the coating layer 12. The coating layer 12 is formed so as to substantially cover all of parts of the roller base 10 except for the bore 10e. In other words, the coating layer 12 is constituted by a base section 12a disposed on an outer surface of the roller base 10 so as to cover the outer surface, follow the outer surface and have a constant thickness; and the elastic ridges 11 projecting from the base section 12a.

In the second example shown in FIGS. 4 to 9, the roller base 10 is not brought into direct contact with a skin when the massage roller 1 is pressed against a face having the skin via the coating layer 12. The coating layer 12 is made of a synthetic resin and free of resin-allergy as described above. Thus, the arrangement according to the second example provides the massage roller 1 with a soft feeling of touch and minimizes the occurrence of a rough skin or resin allergy caused by the use of the massage roller.

In the second example shown in FIGS. 4 to 9, the coating layer 12 may be integrally disposed on the roller base 10 by insert molding where the roller base 10 is utilized as an insert. Or, the coating layer 12 may be integrally disposed on the roller base 10 by simultaneously molding the roller base 10 and the elastic ridges 11 in two-color molding.

When the roller base 10 is made of a synthetic resin, the synthetic resin forming the coating layer 12 is preferred to be fit to the synthetic resin forming the roller base 10.

Each of the elastic ridges 11 is configured to have a distance y from a root to a leading edge thereof, which is longer than 2 mm and shorter than 10 mm. Adjacent elastic ridges 11 and 11 are spaced at intervals of at least 4 mm and at most 7 mm.

The mimetic muscles have a multilayer structure. In particular, the mimetic muscles include an orbicularis oris muscle, a levator anguli oris muscle, a buccinator muscle or a mentalis muscle is present in a fourth layer as the lowest layer, on which the other mimetic muscles are present in a three-layer structure.

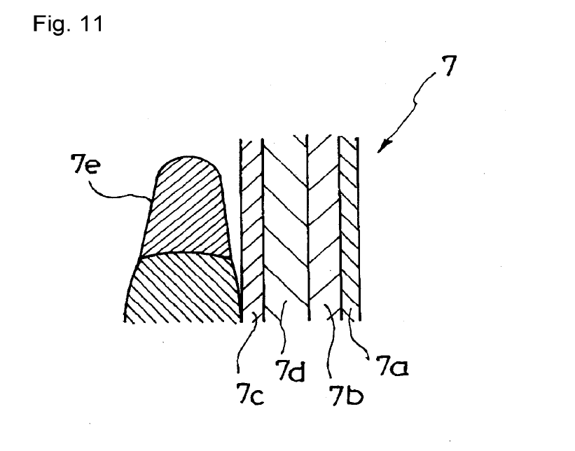

FIG. 11 schematically shows a cheek part 7 of the face of a human body in section. Reference symbol 7a designates a skin, reference symbol 7b designates a fat layer, reference symbol 7c designates a buccal mucosa, reference symbol 7d designates mimetic muscles in the four-layer structure, and reference symbol 7e designates a tooth.

According to measurements using a known measuring instrument, mimetic muscles layered in the four-layer structure have a thickness of about 5 mm in an area where a levator anguli oris muscle is present at an upper corner part of mouth, and of about 7.5 mm in an area where a cheek part is present at a lateral part of mouth shown in FIG. 11. The skin 7a has a thickness of about 1 mm, and the buccal mucosa muscles 7c have a thickness of about 0.5 mm. This means that the total thickness of the skin 7a, the fat layer 7b and the mimetic muscle 7d in a four-layer structure in the thickest cheek part at the lateral part of mouth is about 7.0 mm. When the massage roller 1 is pressed against a face, the fat layer 7b and the mimetic muscle 7d are compressed to about a half of the total thickness of the fat layer and the mimetic muscle.

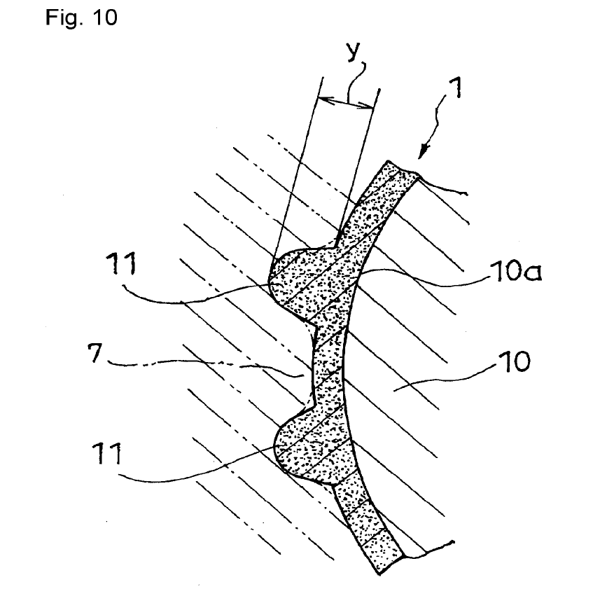

In a case where each of the elastic ridges 11 has a distance from a root to a leading edge thereof, which is at most 2 mm, when the massage roller 1 is pressed against a face, a part of the circumferential roller surface 10a in the second example and a part of the base section 12a of the coating layer 12 in the second example between adjacent elastic ridges 11 and 11 are brought into close contact with a skin 7a with the result that the elastic ridges 11 are prevented from deeply biting into the skin (see FIG. 10).

From this point of view, each of the elastic ridges is configured to have a distance y from the root to the leading edge thereof, which is longer than 2 mm and shorter than 10 mm. Thus, it is possible to effectively apply an external force via the massage roller 1 to respective mimetic muscles having a multilayer structure.

Since the massage roller 1 is configured to combine the roller base 10 made of a material free of elastic deformation, and the elastic ridges 11 achieving elastic deformation, and since the massage roller 1 is pressed against a human face as in finger-pressure treatment while the massage roller is rotated and moved on the face, the massage roller applies a similar effect to finger-pressure treatment to the face skin without damaging the face skin. In other words, the roller base 10 works so as to correspond to a finger bone in finger-pressure treatment while each of the elastic ridges 11 work so as to correspond to the flesh of a finger pad in finger-pressure treatment. The massage roller applies, at a contact end with the face, a sufficient load to the mimetic muscle to be trained as in finger-pressure treatment since the massage roller is brought into contact with the human body with the elastic ridges 11 formed on the circumferential roller surface 10a following the spherical surface of an imaginary globe. Since the massage roller 1 includes the elastic ridges 11 along the axis of rotation x of the roller base, the massage roller is rotated and moved on the skin along the continuously extending direction of the mimetic muscle to be trained such that the load is applied in a direction to loosen and apply a shear stress to myofibrils forming the mimetic muscle to be trained, in order to promote metabolism of the mimetic muscle.

Typically, the massage roller 1 may be used such that the massage roller 1 is pressed against a face, and is rotated and moved on the face, being held at the grip of the support 2, with the elastic ridges 11 being pressed against the human body at a load of from 15 g to 30 g per 1 mm².

The massage roller 1 may be used, being heated to a temperature of from 38° C. to 43° C. The use of the massage roller 1 in such a heated state may be achieved by providing the roller base 10 with a known built-in heater, not shown, generating heat by energization, and utilizing a known alarm system notifying that the massage roller 1 has been heated to a certain temperature by the heater. It is supposed that a training method described later is performed by use of the massage roller 1 thus heated, even when there is progression of muscle atrophy by aging.

The training method according to this embodiment is carried out such that a mimetic muscle to be trained is contracted in a contracting direction, with a portion of a face corresponding to one end portion of the mimetic muscle being pressed so as to pull the mimetic muscle in a direction opposite to the contracting direction, while the massage roller is reciprocated along a continuously extending direction of the mimetic muscle.

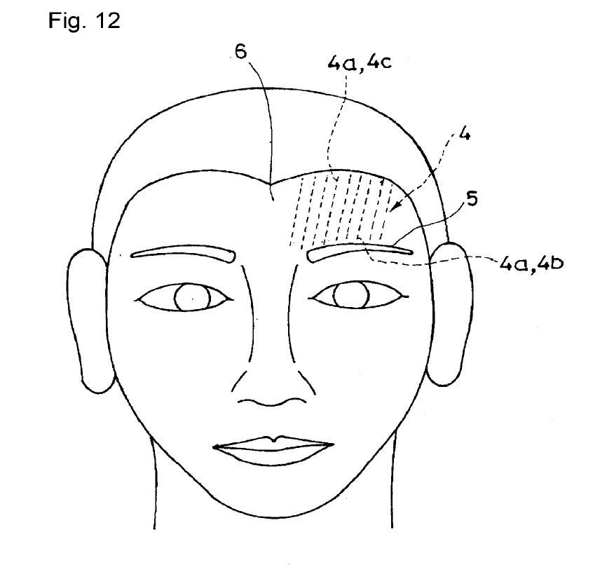

A procedure will be described in reference to FIGS. 12 to 15 in a case where a mimetic muscle to be trained is a frontal muscle 4. The frontal muscle 4 is a mimetic muscle which is contracted to raise his or her eyebrows to wrinkle his or her forehead. The frontal muscles 4 have one of end portions 4a, which starts with a point 4b adhering to the skin of his or her nasal root, medial angles of eye or glabella and the other end portion 4a, which ends with a point 4c adhering to his or her epicranial aponeurosis (see FIG. 12).

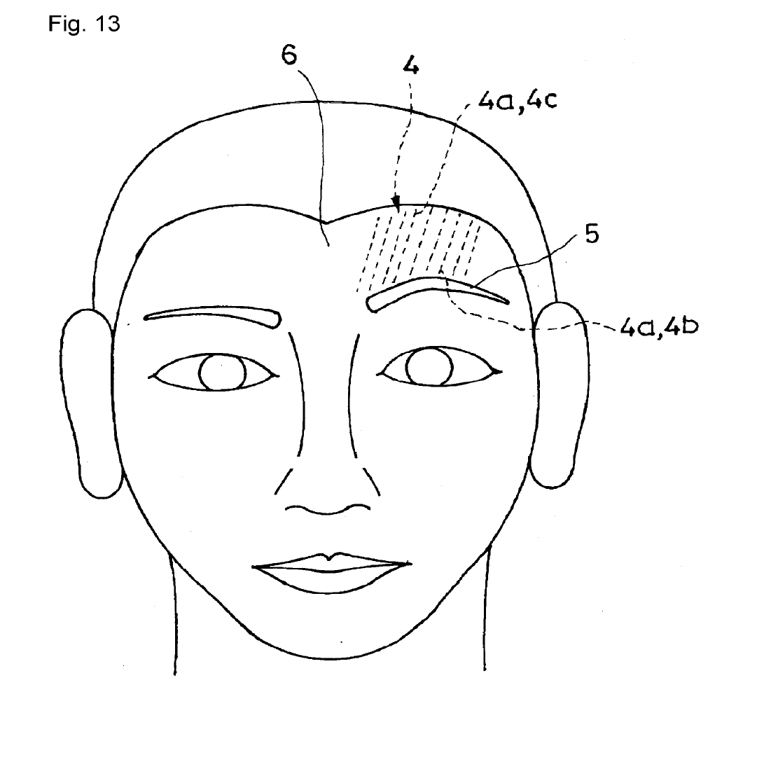

First, the frontal muscles 4 are contracted as shown in FIG. 13. In other words, a user creates a facial expression where his or her eyebrow 5 is raised to wrinkle the forehead 6. Thus, a first load is applied to a mimetic muscle to be trained. The mimetic muscle to be trained is preferred to be contracted to the limit. In other words, when frontal muscles 4 should be trained, it is preferred to raise the eyebrow 5 to the maximum.

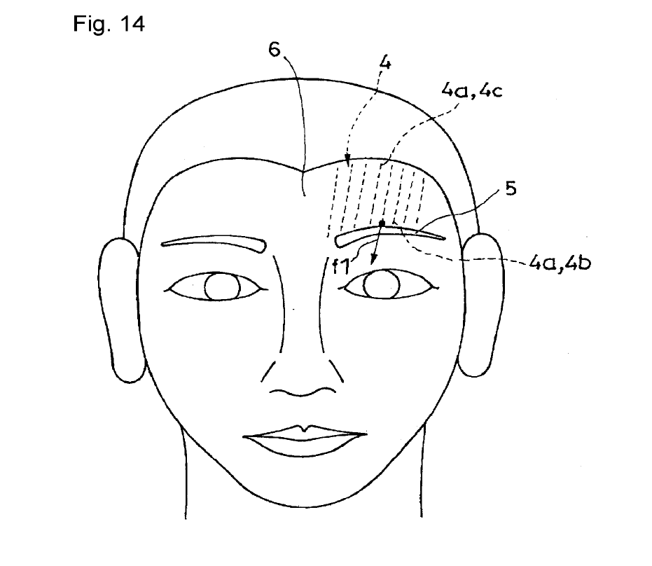

Next, as shown in FIG. 14, a finger is pressed against the face skin at the starting point 4b as the one end portions 4a of the frontal muscles 4 and pull the frontal muscles 4 in a direction opposite to the contracting direction (the direction denoted by reference symbol f1 in FIG. 14). Thus, a second load is applied to the mimetic muscle to be trained.

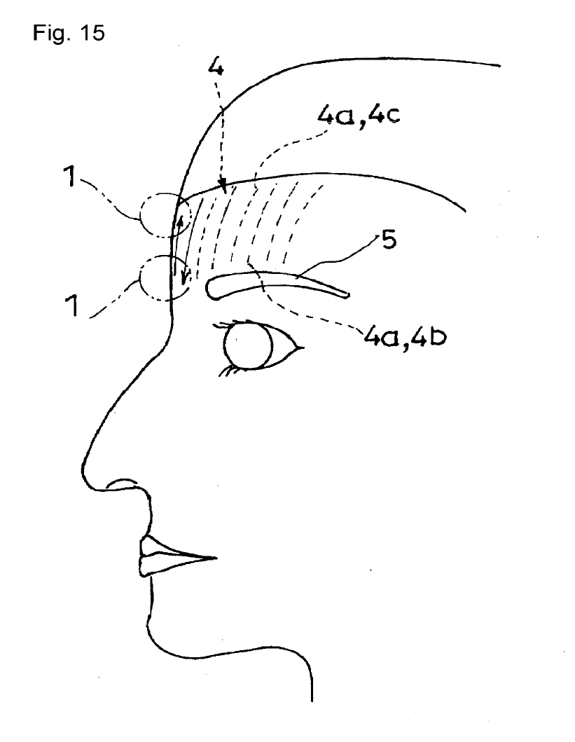

Then, in the state shown in FIG. 14, in other words, in a state where the first load and the second load have been applied to the frontal muscles 4, the massage roller 1 is reciprocated along the continuously extending direction of the frontal muscles 4 (the contracting/stretching direction of the frontal muscles 4) as shown in FIG. 15. In other words, the massage roller 1 is reciprocated along muscle fibers of the frontal muscle 4 as the mimetic muscle. A reciprocating movement where one cycle includes the travel of the massage roller 1 from the starting point 4b toward the ending point 4c of the frontal muscles 4 and the travel of the massage roller 1 from the ending point 4c toward the starting point 4b is repeated.

It is possible to give a similar effect to finger-pressure treatment for training to the mimetic muscle to be trained by reciprocating the massage roller 1 along the continuously extending direction of the mimetic muscle in a state where the first load and second load are applied to the mimetic muscle.

The method for training another mimetic muscle than the frontal muscles 4 is the same as the method for training the frontal muscles 4 in that the massage roller 1 is reciprocated along the continuously extending direction of a mimetic muscle in a state where the first load and the second load are applied. For this reason, specific explanation will be omitted.

A specific mode of a training method using the massage roller, which is considered as being appropriate, is as shown:

State of mimetic muscle: A muscle to be trained is contracted by creating a specific expression, and the muscle is pulled in a direction opposite to the contracting direction with a stopping side (movable side) of the muscle being pressed, resulting in a state where the muscle is firmly tensioned.

Pressing pressure: a level where a finger-pressure effect caused by elastic ridges is felt at the muscles.

Training strength: a level where training is not hard, and a light feeling of tension is felt at the muscles.

Reciprocating speed: from 0.3 to 1.2 sec.

Period of time: from 15 to 60 sec. for one part of a human body

Frequency of reciprocation: 50 to 60 times per one set

Number of setting times: two to four times

Frequency: two to three times per week

Of course, it should be construed that the present invention is not limited to the embodiments described above, and that the present invention covers all embodiments that attain the object of the invention.

This application is a continuation of PCT Application No. PCT/JP2017/022829, filed on Jun. 21, 2017, which is based upon and claims the benefit of priority from PCT Application No. PCT/JP2016/070678 filed on Jul. 13, 2016. The contents of those applications are incorporated herein by reference in their entireties.

What is claimed is:

1. A method for training a mimetic muscle, comprising preparing a massage roller, the massage roller including a roller base made of a material free of elastic deformation, and a plurality of elastic ridges formed on a circumferential roller surface of the roller base so as to continuously extend in a direction along an axis of rotation of the roller base such that adjacent ridges in a rotational direction of the roller base are spaced; and
creating a certain facial expression on a face so as to contract, in a contracting direction, a mimetic muscle to be trained; and reciprocating the massage roller along a continuously extending direction of the mimetic muscle with a location of a face skin corresponding to one end portion of the mimetic muscle being pressed so as to pull the mimetic muscle in a direction opposite to the contracting direction.

2. A massage roller comprising a roller base made of a material free of elastic deformation, and a plurality of elastic ridges formed on a circumferential roller surface of the roller base so as to continuously extend in a direction along an axis of rotation of the roller base such that adjacent ridges in a rotational direction of the roller base are spaced; and
the roller base having a coating layer disposed on the circumferential roller surface, the coating layer being made of a synthetic resin having a rubber-like elasticity and free of resin-allergy; and the elastic ridges being formed of parts of the coating layer, and each of the elastic ridges having a distance from a root to a leading edge thereof, which is within a range longer than 2 mm and shorter than 10 mm.
